(19) United States
(12) Patent Application Publication
(10) Pub. No.: US 2004/0240164 A1
(43) Pub. Date: Dec. 2, 2004

(54) Portable case for a notebook computer

(76) Inventor: Tom Lee, Tao Yuan City (TW)

Correspondence Address: PRO-TECHTOR INTERNATIONAL SERVICES, 20775 Norada Court, Saratoga, CA, 95070-3018, US

(21) Appl. No.: 10/447,378

(22) Filed: May 28, 2003

(51) Int. Cl. G06F 1/16

(52) U.S. Cl. 361/683

(57) ABSTRACT

A portable case for a notebook computer includes a foldable board and a first fixing member. The foldable board has a plurality of board bodies, which is foldable and connected together. The foldable board may be folded to form a base, a rear board, and a top board. The first fixing member is arranged between an internal surface of the base and a bottom surface of the notebook computer to mount the notebook computer to the base.

### BACKGROUND OF THE INVENTION

1. Field of the Invention

The invention relates to a portable case, and more particularly to a portable case for a notebook computer.

2. Description of the Related Art

Currently, a notebook computer is often completely packaged by a bag similar to a suitcase and then the bag may be carried. However, the bag has the following drawbacks.

1. When the notebook computer is used, the notebook computer has to be removed from the bag and the bag has to be placed aside. When the notebook computer is not used, the user has to find the bag and put it into the bag.

2. The bag simply provides the portable function without any additional function such as serving as a support, heat insulating, vibration absorbing, and the like.

In order to miniaturize the notebook computer and made it portable, some functions of the notebook computer have to be compromised according to the following considerations.

1. Ergonomics Consideration:

Since a distance from the eye to the elbow of an adult is about 50 cm but the height of a typical notebook computer is about 30 cm, the head of the user has to hang down when he or she uses the notebook computer. In addition, unlike the slant keyboard of a desktop computer, the keyboard of the notebook computer is flat and does not satisfy ergonomics.

2. Heat-Dissipation Consideration:

Due to the space limitation of the notebook computer, if the notebook computer is placed on the lap, the hot air exhausted from the heat-dissipating holes may hurt the organs such as the male reproductive organs of the human body. In addition, the heat-dissipating holes are formed on the bottom of the computer and may be blocked and thus have poor heat-dissipating effects if the computer is placed on the lap.

3. Vibration Absorbing Consideration:

The hard disk drive for the notebook computer tends to be easily damaged in the vibrating condition. The computer with vibration-absorbing functions may occupy larger space. However, the notebook computer has limited vibration-absorbing functions because its volume is small.

Since the notebook computer is a portable device, the user may usually place it on the thighs and then operate the computer. If there is no good heat-insulation effects, the computer may hurt the user's body. Furthermore, when the notebook computer is operated in a moving car, proper vibration absorbing effects have to be provided. Consequently, it is an important object of the invention to provide a portable case for a notebook computer, wherein the portable case may additionally serve as a support and provide heat insulating and vibration absorbing functions.

### SUMMARY OF THE INVENTION

An object of the invention is to provide a portable case, which may be folded under a notebook computer to elevate the notebook computer and provide heat insulation function and convenience for the user.

Another object of the invention is to provide a portable case, which may be folded under a notebook computer to form a slant and elevated support satisfying ergonomics.

Still another object of the invention is to provide a portable case, which may be folded under a notebook computer to form a buffer capable of absorbing vibrations.

To achieve the above-mentioned objects, the invention provides a portable case for a notebook computer. The portable case includes a foldable board and a first fixing member. The foldable board has a plurality of board bodies, which is foldable and connected together. The foldable board may be folded to form a base, a rear board, and a top board. The first fixing member is arranged between an internal surface of the base and a bottom surface of the notebook computer to mount the notebook computer to the base.

Furthermore, the top board may include at least two foldable board bodies, and the portable case may further include a second fixing member mounted to external surfaces of the base, the rear board, the top board and the front board.

### BRIEF DESCRIPTION OF THE DRAWINGS

FIG. 1 is a developed top view showing a portable case according to a first embodiment of the invention.

FIG. 2 is a developed bottom view showing the portable case according to the first embodiment of the invention.

FIG. 3 is a side view showing the portable case for packaging a notebook computer according to the first embodiment of the invention.

FIG. 4 is a side view showing a first state of the portable case according to the first embodiment of the invention.

FIG. 5 is a side view showing a second state of the portable case according to the first embodiment of the invention.

FIG. 6 is a side view showing a third state of the portable case according to the first embodiment of the invention.

FIG. 7 is a side view showing a fourth state of the portable case according to the first embodiment of the invention.

FIG. 8 is a side view showing a portable case according to a second embodiment of the invention.

FIG. 9 is a side view showing a portable case according to a third embodiment of the invention.

### DETAILED DESCRIPTION OF THE INVENTION

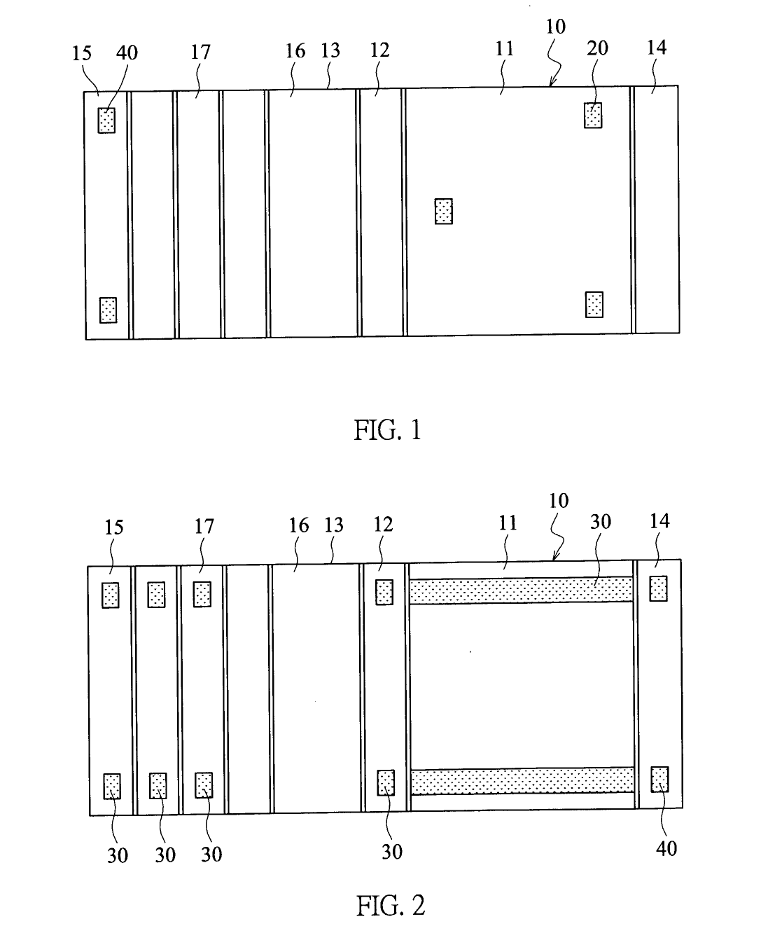

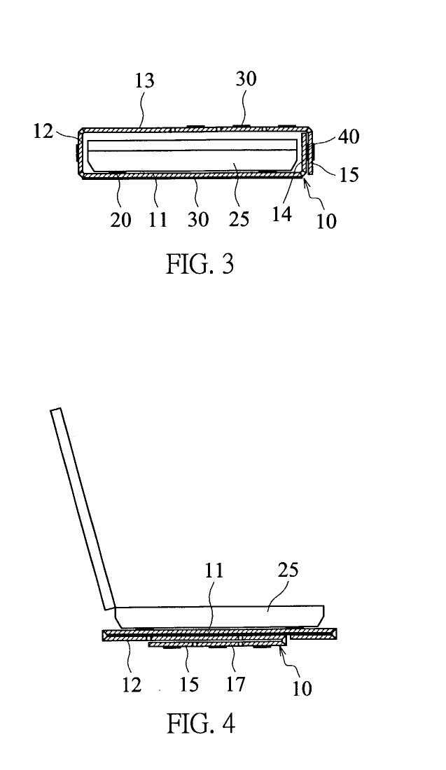

Referring to FIGS. 1 to 3, a portable case according to a first embodiment of the invention includes a foldable board 10, first fixing members 20, second fixing members 30, and third fixing members 40.

The foldable board 10 has a plurality of board bodies, which is connected together and foldable. The foldable board 10 may be folded to form a base 11, a rear board 12, a top board 13, a first front board 14 connected to the base 11, and a second front board 15 connected to the top board 13. The top board 13 is composed of a larger first board 16 connected to the rear board 12, and three smaller second boards 17.

The first fixing members 20 are arranged between the internal surface of the base 11 of the foldable board and the bottom surface of a notebook computer 25 to mount the notebook computer 25 to the base 11. The first fixing member 20 may be of a fastener tape type, a button type, or a magnetic type. In this embodiment, the first fixing member 20 is of the fastener tape type.

The second fixing members 30 are mounted to two sides of external surfaces of the base 11, the rear board 12, the top board 13 and the second front board 15. Only two second boards 17 close to the second front board 15 of the top board 13 have the second fixing members 30 mounted thereon. The second fixing member 30 may be of a fastener tape type, a button type, or a magnetic type. In this embodiment, the second fixing member 30 is of the fastener tape type.

The third fixing members 40 are mounted to two sides of an external surface of the first front board 14 and two sides of an internal surface of the second front board 15 such that the first front board 14 may be fixed to the second front board 15 via the third fixing members 40. The third fixing member 40 may be of a fastener tape type, a button type, or a magnetic type. In this embodiment, the third fixing member 40 is of the fastener tape type.

As shown in FIG. 4, when the notebook computer 25 is to be used, the foldable board 10 may be folded and positioned under the notebook computer 25 without removing the case and placing the case aside as performed in the prior art. So, it is very convenient to use the case.

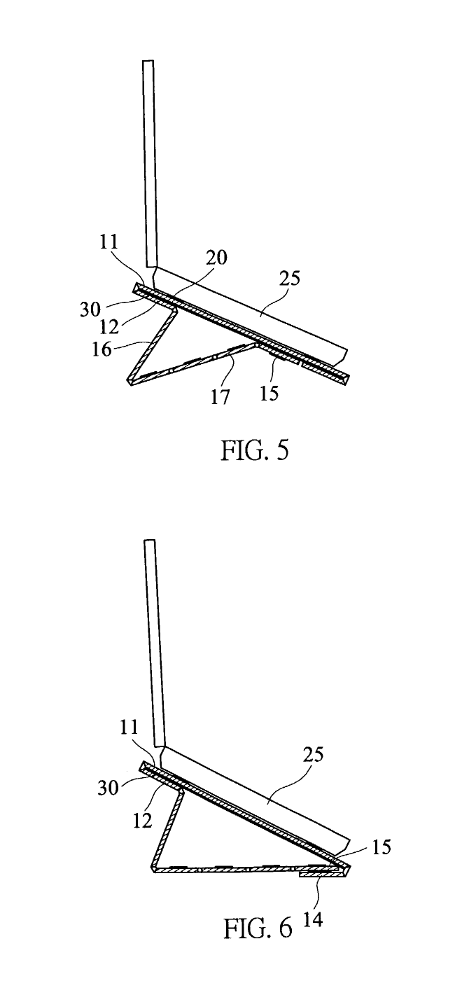

As shown in FIG. 5, when the rear board 12 is fixed to the base 11 via the second fixing members 30 and the second front board 15 is fixed to the base 11 via the second fixing members 30, the foldable board may become a slant and elevated support for slanting the notebook computer 25 so as to satisfy ergonomics and make the operation more comfortable. The notebook computer 25 is fixed to the base 11 via the first fixing members 20 and will not slide downward.

As for another state of the invention, as shown in FIG. 6, when the rear board 12 is fixed to the base 11 via the second fixing members 30, and the first front board 14 is folded back, positioned under the second front board 15, and fixed to the second front board 15 via the third fixing members 40, the foldable board may become another slant support.

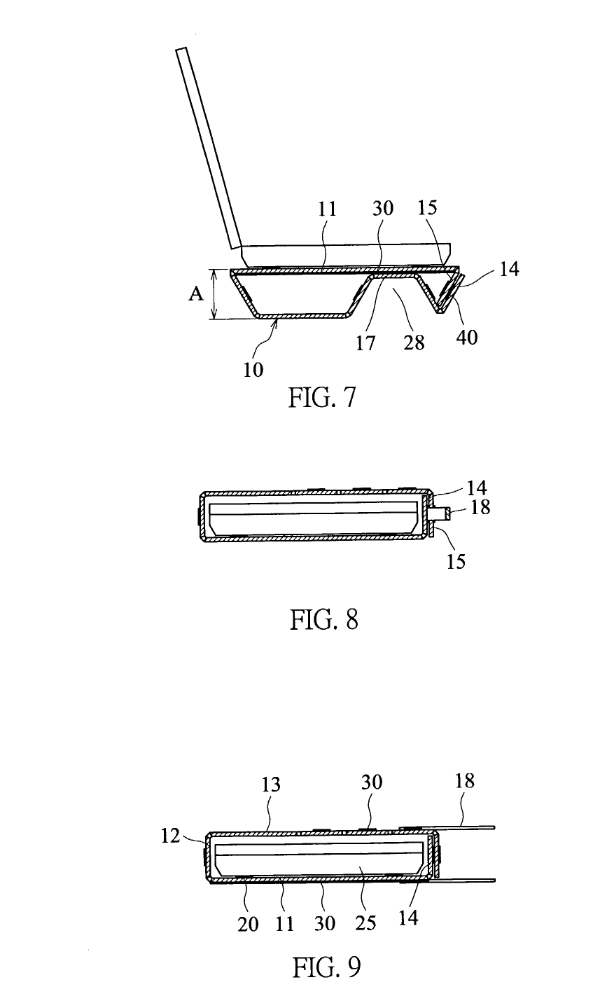

As shown in FIG. 7, when the middle second board 17 is fixed to the base 11 via the second fixing members 30 and the first front board 14 is fixed to the second front board 15 via the third fixing members 40, the foldable board 10 may be folded back and positioned under the bottom surface of the notebook computer 25 to form a buffer with a height A and a cavity 28. In this case, the buffer may absorb vibrations according to the formed cavity in conjunction with the associated movements in the foldable board 10.

Consequently, the invention has the following advantages.

1. When the notebook computer is to be used, the user only need to fold the foldable board under the notebook computer. So, the portable case may be conveniently used. In addition, when the notebook computer is to be packaged, the user may make the foldable board become the portable case without worrying about the loss of the foldable board.

2. The foldable board may be folded back under the notebook computer to elevate the computer and to provide heat-insulation effect.

3. The foldable board may be folded back under the notebook computer to form a slant and elevated support for supporting the notebook computer and satisfying ergonomics.

4. The foldable board may be folded back under the notebook computer to form a buffer for absorbing vibrations.

As shown in FIG. 8, a handle 18 is provided and connected to the first front board 14, and the second front board 15 is formed with an opening through which the handle 18 passes. Thus, the portable case may be carried as a suitcase.

As shown in FIG. 9, two handle 18 extending frontward are provided and connected to the external surfaces of the base 11 and the top board 13, respectively.

In addition, a shoulder strap may be connected to the portable case of the invention at right and left sides of the portable case when the notebook computer 25 is packaged. In this case, the right and left sides of the notebook computer 25 may be covered and the portable case may be carried on the shoulder of the user.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A portable case for a notebook computer, comprising:
a foldable board having a plurality of board bodies, which is foldable and connected together, wherein the foldable board may be folded to form a base, a rear board, and a top board; and
a first fixing member arranged between an internal surface of the base and a bottom surface of the notebook computer to mount the notebook computer to the base.

2. The portable case according to claim 1, wherein the first fixing member is a fastener tape.

3. The portable case according to claim 1, wherein after the foldable board is folded, at least one front board corresponding to the rear board is formed at a front end.

4. The portable case according to claim 3, wherein the first fixing member is a fastener tape.

5. The portable case according to claim 1, wherein the foldable board comprises a first front board connected to the base, and a second front board connected to the top board, and the first and second front boards correspond to the rear board.

6. The portable case according to claim 5, wherein the first fixing member is a fastener tape.

7. The portable case according to claim 1, wherein the top board comprises at least two foldable board bodies, and the portable case further comprises a second fixing member mounted to the base, the rear board and the top board.

8. The portable case according to claim 7, wherein the second fixing member is a fastener tape.

9. The portable case according to claim 3, wherein the top board comprises at least two foldable board bodies, and the portable case further comprises a second fixing member mounted to the base, the rear board, the top board and the at least one front board.

10. The portable case according to claim 9, wherein the second fixing member is a fastener tape.

11. The portable case according to claim 9, wherein the top board is composed of a first board and three second boards, and the first board is larger than each of the second boards.

12. The portable case according to claim 11, wherein the second fixing member is a fastener tape.

13. The portable case according to claim 5, wherein a third fixing member is mounted to the first front board and the second front board to fix the first front board to the second front board.

14. The portable case according to claim 13, wherein the third fixing member is a fastener tape.

15. The portable case according to claim 5, further comprising a handle connected to the first front board, and the second front board is formed with an opening through which the handle passes.

16. The portable case according to claim 1, further comprising two handles connected to external surfaces of the base and the top board, and the handles extending frontward.
